(19) United States
(12) Patent Application Publication
(10) Pub. No.: US 2017/0334517 A1
(43) Pub. Date: Nov. 23, 2017

(54) Bicycle Equipped with Versatile Dual Chain Drive

(71) Applicant: Antonie Zuniga, Chilliwack (CA)

(72) Inventor: Antonie Zuniga, Chilliwack (CA)

(21) Appl. No.: 15/602,100

(22) Filed: May 22, 2017

(30) Foreign Application Priority Data
May 20, 2016 (CA) 2930589

(51) Int. Cl. B62M 9/02; B62K 3/08; B62M 1/36; B62K 3/06

(52) U.S. Cl. CPC B62M 9/02; B62M 1/36; B62K 3/08; B62K 3/06; B62M 2700/003

(57) ABSTRACT

A bicycle is equipped with a dual chain drive system having two cranksets symmetrically mounted on the rear section of an adapted and compact frame. The cranksets are located in close proximity to the rear wheel hub axle to enhance the energy efficiency, responsiveness and manoeuvrability of the bicycle.

### TECHNICAL FIELD

The present invention relates to bicycles and in particular to bicycle frames and bicycle drivetrains.

### CROSS REFERENCE TO RELATED APPLICATIONS

This application claims priority from Canadian patent application No. 2,930,589 filed May 20, 2016.

### BACKGROUND

People have been riding bicycles for more than a century and the pastime is so popular that it has evolved into a myriad of disciplines. Among them, freestyle bicycles continue to attract a great deal of attention. Freestyle bicycles are those used to perform creative, extreme and physically demanding stunts on streets, parks, trails, flatlands or ramps. Although freestyle bicycles are normally associated with BMX bicycles, there are also Mountain Bike Trials, also known as Trials bikes, and fixed gear freestyle bicycles, also known as FGFS, that have gained popularity in recent years. Some riders ride both fixed gear and freewheel gear bicycles.

Freestyle bicycles typically are single speed, light in weight, have thick tires, ample standover height, head tube angles between seventy and seventy-five degrees, short chainstay lengths, low saddle height or no saddle, pronounced slope top tubes, BMX or riser handle bars, sturdy frame construction, freewheel or fixed gear hubs, and no suspension systems.

In recent years manufacturers of freestyle bicycles have introduced new bicycle designs and component variations to improve handling, balance and performance, such as wider tires, lighter frames and components, frames without seat tubes and raised bottom brackets. Manufacturers remain constrained by limitations of conventional freestyle bicycle design. This constraint has prevented more significant improvements.

One lacking improvement is the development of a more energy efficient bicycle drivetrain. An efficient drivetrain is essential for bicycle riders' better transmission of power and control of their bikes during extreme manoeuvres. The single chain drive arrangement in conventional bicycles suffers from a loss of energy efficiency between the power applied to the pedals and the power actually applied to rotate the wheel. Bicycle manufacturers have sought to shorten chainstay distance, namely the horizontal distance between the centre of the rear wheel hub axle and the bottom bracket centre, as a way of improving drivetrain efficiency in freestyle bicycles.

Short chainstays imply shorter chains, less chain weight, and less physical effort to transmit pedaling power from the cranksets to the rear hub sprockets thus energy is more effectively transmitted between chainring and rear hub sprocket. Moreover, short chainstays do not have much sideways flex, so less energy is lost to frame movement while pedaling which allows for more immediate power delivery to the rear wheel. Bikes with short chainstays are more responsive and therefore climb and accelerate well. Shortened chainstays make a bike easier to manual and bunny hop. Short chainstays also make a bike easier to control in the air. Furthermore the length of a bike's chainstay directly affects wheelbase length which affects manoeuvrability and stability since the shorter the chainstay the shorter the possible wheelbase.

Climbing walls, extreme slopes, rocks and other obstacles require an optimal transmission of power from the crankset to the rear wheel. When the bicycle is at a steep inclination angle, during wheelies for example, every gain in power efficiency is essential in order to maintain effective control of the bicycle and succeed at completing tricks. Bicycles with short chainstays have more power-efficient drivetrains than bicycles with long chainstays and thus are preferred by riders of freestyle bicycles in order to successfully complete stunts.

While bicycle manufacturers and frame builders have shortened chainstay length to improve the energy efficiency of the drivetrain, this reduction on conventional frame bicycles can only go as far as the diameter of rear wheel allows given the location of the bottom bracket, which is generally perpendicular to, and in front of, the rear wheel.

Thus it is desirable to have a design that allows for the crankset to shift closer to the rear wheel hub regardless of the bicycle's rear wheel diameter to optimize the transfer of power from the cranksets to the rear hub. A shorter chainstay would also mean a shorter wheelbase and a shorter, more compact, frame which can improve handling and manoeuvrability.

A shorter chainstay shifts the centre of gravity closer to the rear wheel and improves equilibrium and control. The centre of gravity is approximately located above and slightly towards the front of the bottom bracket and sometimes along the down tube. When performing tricks involving the lifting the front wheel, which is a fundamental part of freestyle riding, it is important to ride a bicycle with the centre of gravity as close as possible to the point of support, which is the part of the rear tire in contact with the ground, for better equilibrium. That is another reasons why freestyle bike manufactures strive to shorten the chainstays' length.

Freestyle bikes often have shorter chainstays than most other bikes. This reduction shifts the bottom bracket shell and the crankset closer to the rear wheel which in turn shifts the centre of gravity in the same direction, given that the bottom bracket shell and the crankset are relatively heavy components of a bicycle. Having shorter chainstays and a centre of gravity closer to the rear wheel point of support makes balancing on the rear wheel easier and allows for more precision stunts during rear wheel moves. Shorter chainstays also make pulling the front wheel up easier for bunny hops and other similar moves. However, the chainstays length in conventional freestyle bicycles can only be as short as the rear wheel tire diameter allows. Any improvements in the design of bicycles to further optimize the centre of gravity of a bicycle in relation to the point of support would require a revision of conventional bicycle design.

For fixed gear riders who would like to ride freewheel gear bicycles, and vice versa, switching between those two disciplines is time consuming and inconvenient. The switch normally entails either switching bicycles altogether or changing a tire or a rear hub, which takes time and effort. Those riders who enjoy riding both styles of bicycles do not have at present much in terms of convenient options.

Significant improvements to freestyle bicycles have been limited by the conventional design of bicycles which has not allowed for the development of a more energy efficient drivetrain. It is desirable to conceive a new and innovative bicycle design that can allow for the mounting of a versatile energy efficient drivetrain that would improve freestyle bicycles performance while at the same time improving the gear options for riders.

Single chain drive arrangements in bicycles suffer from a loss of energy between the torque applied to the pedals and the power actually transferred to rotate the wheel. This is in part due to the flexing of the right side pedal operated crank under the stress of the pedalling action. Bicycle frames are not perfectly rigid, so chain tension causes them to flex sideways. To address the loss of energy and to propose more energy efficient drive trains, inventors have sought to design dual chain drives. In other words inventors have proposed installing an additional chain drive to the left side of the rear section of the frame which includes a chainring at the left end of the bottom bracket, as well as a chain, a sprocket and a double sided rear hub in their designs.

An early example of this layout is seen in U.S. Pat. No. 426,855 to Reed. One of the issues with this layout is that while a symmetrical chain drive may improve the transmission of energy from the pedals to the rear wheel, the additional weight of a chain, a chainring and a sprocket negatively affect the energy efficiency of the overall drivetrain. Thus, while this concept has been available since the 1890's it has not gained popularity.

Other ideas proposed include single bottom bracket dual chain drives and splitting the bottom bracket into two and shifting them closer to the rear wheel hub axle by anchoring them on the chainstay tubes. U.S. Pat. No. 481,476 to Cranmer is a prime example. However, while his design resulted in shorter chainstays it was also clunky due to the number of tubes employed to support both bottom brackets. The result was an excessive Q factor (the distance between the pedal attachment points on the crank-arms, when measured parallel to the bottom bracket axle). Moreover there are no details about the rear hub so one can only assume it employs a fixed gear hub. When compared to today's standards, Cranmer's design was arguably not very functional.

U.S. Pat. No. 615,137 to Caddick discloses a crankset shifted closer to the rear wheel hub utilizing toothed gears in his drivetrain on both sides of the rear section of the frame. Toothed gears, while never went completely away, are not considered the most energy efficient or easy to maintain drivetrains and thus have not been nearly as popular as chain driven gears. Caddick's design is also fixed gear.

More recently, in U.S. Patent Application Publication No. 2011/0266770 A1, Beraka also shifts the cranksets closer to the rear wheel hub. His invention relied on multiple gears to convey the energy generated by the pedals to the right side of the rear wheel through a conventional one sided freewheel. His multiple-gear drivetrain was far more complicated than conventional bicycle drivetrains and thus is not very practical for use in freestyle bicycles.

Dual chain drive bicycles, given their very nature require a double sided rear wheel hub for them to function effectively. Thus proponents of those types of bicycles have proposed different designs of double sided hubs.

U.S. Pat. No. 4,398,740 to Clem and U.S. Pat. No. 3,891,235 to Shelly present rear hubs with two independent ratchets with sprocket mounted on the left and right side. In those designs the hubs were specially designed to assist their single bottom bracket dual chain drives.

While some inventors proposing single bottom bracket double chain drive designs have also proposed matching rear double-sided freewheel hubs, proponents of the split bottom bracket dual chain drives have fallen short of proposing double-sided freewheel hubs suitable to that style of drivetrain. Unfortunately the freewheel hub for the former cannot be utilized for the latter.

Double sided freewheel hubs for single bottom bracket dual chain drives, or as in Shelly's case, for dual chain drive without a split bottom bracket, have ratchets that act independent of each other. In other words the right side ratchet and left side ratchet do not always rotate simultaneously and at the same speed. This type of freewheel hub would not be efficient when installed on a split bottom bracket dual chain drive. In single bottom bracket dual chain drives, the bottom bracket determines and synchronizes the rotation of the rear wheel hub. Thus given the absence of a single bottom bracket and crankset and the independent nature of the two bottom brackets in split bottom bracket dual chain drives, they require a specially designed freewheel hub. They require a hub with sprockets that can rotate simultaneously in any direction and in sync in order for the freewheel to function efficiently.

While fixed gear bikes such as FGFS have gained a lot of popularity, when it comes to pure trick bicycles such as BMX and bike trials, the option of a freewheel is essential. Needless to say, for those who enjoy both freewheel gear and fixed bicycles, a bicycle with a hub that could easily be turned from one type into the other would be desirable. The closest hub design currently in the market is the flip-flop hub upon which riders can mount a free wheel sprocket on one side and a fixed gear sprocket on the other. To switch it, riders need to uninstall the rear wheel, flip it and reinstall it which requires time and effort. It is only available for conventional one-sided drive trains.

Thus despite attempts to improve the energy efficiency of bicycle drivetrains through proposing single bottom bracket dual chain drives or split bottom brackets dual chain drives, the designs proposed thus far are either not very energy efficient, such as the case of the former, or have lacked the functionality of a double-sided freewheel hub such as the case of the later. While inventors of split bottom bracket dual chain drives got it right in that shorter chainstays are more energy efficient, designs proposed thus far are, as demonstrated, in need of further inventive improvement.

### SUMMARY OF INVENTION

A bicycle frame has a top tube, a head tube coupled to the top tube, a down tube coupled to the head tube, and a seat tube coupled to the head tube and the down tube. Left and right chainstay tubes are coupled to the down tube. Left and right seat stay tubes are also coupled to the seat tube. A left dropout is coupled to the left seat stay tube and the left chainstay tube. A right dropout is coupled to the right seat stay tube and the right chainstay tube. A left bottom bracket shell is coupled to the left chainstay tube, and a right bottom bracket shell is coupled to the right chainstay tube. A rear wheel and a set of spokes coupled to the rear wheel. A double sided freewheel hub is coupled to the rear wheel via the spokes and coupled to the left and right dropouts. The rear double sided freewheel hub has a left sprocket and a right sprocket. A left side crankset is coupled to the left bottom bracket shell, the left side crankset having a left chain ring. A right side crankset is coupled to the right bottom bracket shell, the right side crankset having a right chain ring. A left chain is coupled to the left chain ring and to the left sprocket such that rotation of the left side crankset causes the rear wheel to rotate. A right chain is coupled to the right chain ring and to the right sprocket such that rotation of the right side crankset causes the rear wheel to rotate.

### BRIEF DESCRIPTION OF DRAWINGS

In figures which illustrates aspects of non-limiting embodiments of the invention:

FIG. 1 is a side view of a bicycle employing an embodiment of this invention;

FIG. 2 is a perspective view of the frame of the bicycle in FIG.1;

FIG. 3 is a top plan view of the rear section of the FIG. 1 bicycle with saddle and roller chains removed;

FIG. 4 is a fragmentary exploded perspective view of the right side bottom bracket shell of the bicycle in FIG. 1, including a crankset assembly;

FIG. 5 is an isometric perspective view of a split bottom bracket dual chain drive in accordance with an embodiment of the invention;

FIG. 6 is a fragmentary exploded view of a versatile double sided freewheel hub of the bicycle in FIG. 1; and

FIG. 7 is a side view of a frame according to another embodiment of the invention.

For a better understanding of the invention reference is made to the following detailed description of the preferred embodiments thereof which should be taken in conjunction with the prior described drawings.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

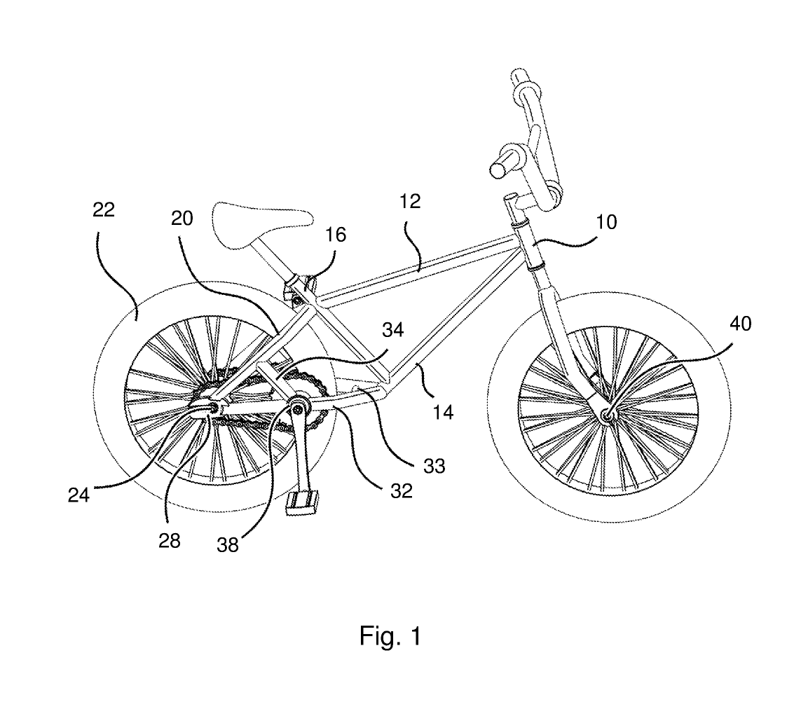

With reference to the figures, FIGS. 1, 2 and 3, show an embodiment of the invention as a split bottom bracket dual chain drive, including a bicycle frame designed for the operation of said drivetrain. In the present embodiment, the bicycle frame is configured by a head tube 10 connected to a top tube 12 and a down tube 14. Said top tube 12 and down tube 14 are linked at the opposite ends to a seat tube 16 to which a seat post 15 can be installed at the upper end. Connected near the top tube 12 and seat tube junction are seat stays, a left seat stay 18 and a right seat stay 20, which extend rearward around the rear wheel 22 toward the rear wheel hub axle 24 and terminate in dropouts, a left dropout 26 and a right dropout 28, to which a rear wheel 22 is mounted in via the rear wheel hub axle 24. Connected to the dropouts below the seat stays junctions are two chainstay tubes, a left chainstay 30 and a right chainstay 32, which extend forward and are connected at their opposite end to the bottom bracket shells, a left bottom shell 36 and right bottom bracket shell 38. The chainstays 30 and 32 then link, the opposite side of the bottom bracket shells 36 and 38 to the down tube 14 near the junction where the down tube 14 connects to the seat tube 16. The chainstays 30 and 32 are linked to each other through the chainstay bridge tube 33 which is connected to both chainstays 30 and 32 just before the chainstays intersect the down tube 14.

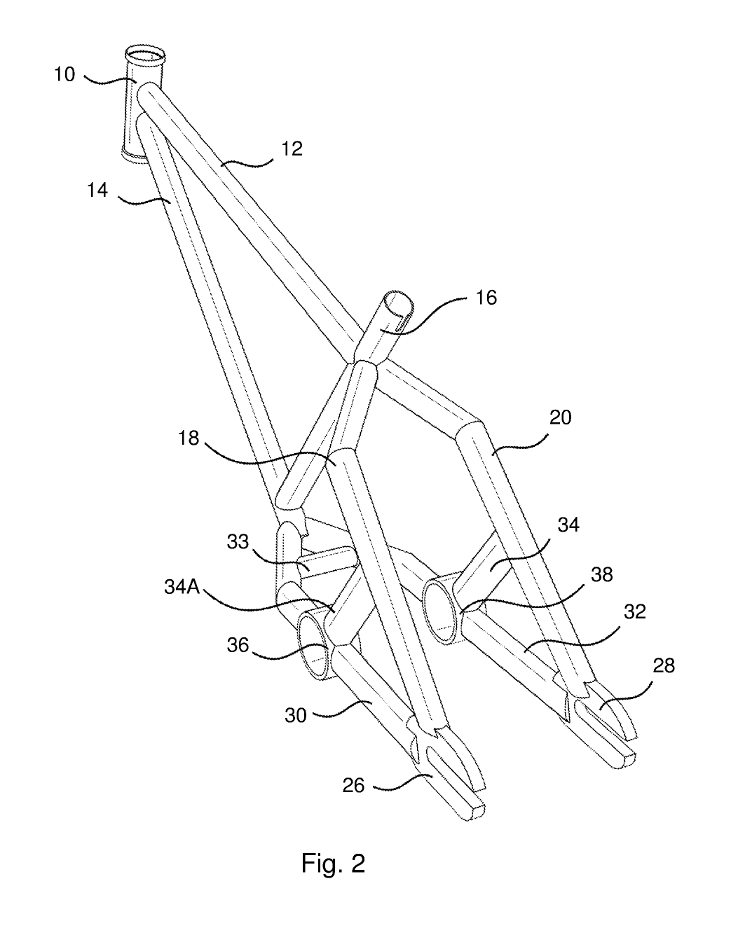

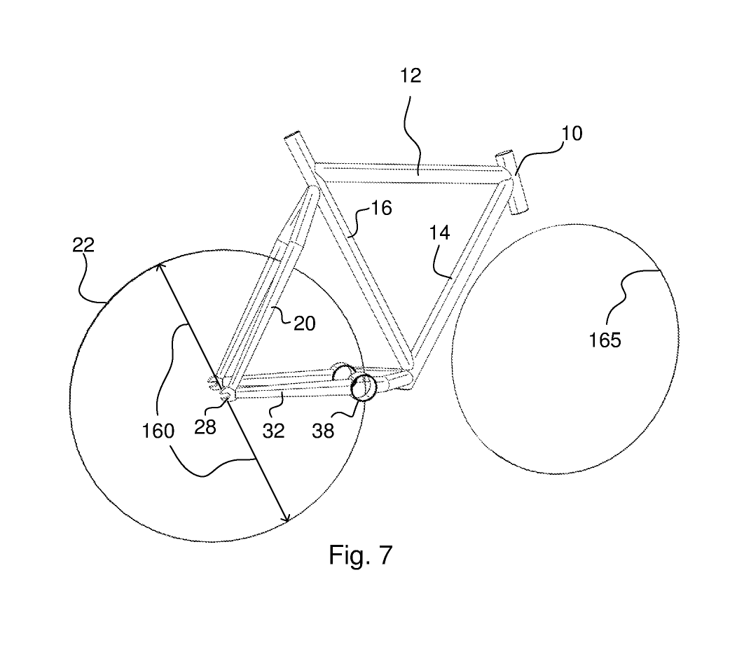

Referring to FIGS. 1 and 2, a left side seat stay bridge tube 34A and a right side seat stay bridge tube 34 connect the seatstays 18 and 20, to the bottom bracket shells 36 and 38, and reinforce the rear section of the frame by forming two triangular frame structures, one on each side. In alternative embodiments as in FIG. 7, the frame does not require seat stay bridge tubes as the frame may not be subjected to the structural stresses of freestyle bicycles. In other alternative embodiments, the entire bicycle frame or parts of it can be built of a rigid unibody construction.

Referring to FIGS. 2, 3 and 5, the two bottom bracket shells 36 and 38 are identical, parallel and have perfectly aligned centre axles. Said bottom bracket shells 36 and 38 are located on the chainstay tubes 30 and 32 alongside the rear wheel 22.

In the embodiment of FIG. 1 the frame is shown to be made of tubes and bottom bracket shells that are welded together. In other embodiments, the bicycle frame can be built of a rigid unibody construction. Yet in other alternative embodiments the frame can be made of separate parts that are screwed or otherwise connected to one another.

The frame components for the present invention are preferably formed of aluminium, chromolly, steel or titanium. However, it is understood by those skilled in the art, that other materials, such as carbon fiber and composite materials, which exhibit high strength and light weight characteristics, are also suitable for the frame components. As well, the bicycle frame in the present invention can be built from differently shaped tubes such as, but not limited to, oval, circular, square, tapered or rectangular profile tubes.

The frame in the present embodiment of FIG. 1 is designed to fit twenty inch tires. In other embodiments, the frame and components can be configured to accept larger or smaller size wheels without departing from the spirit and scope of the invention.

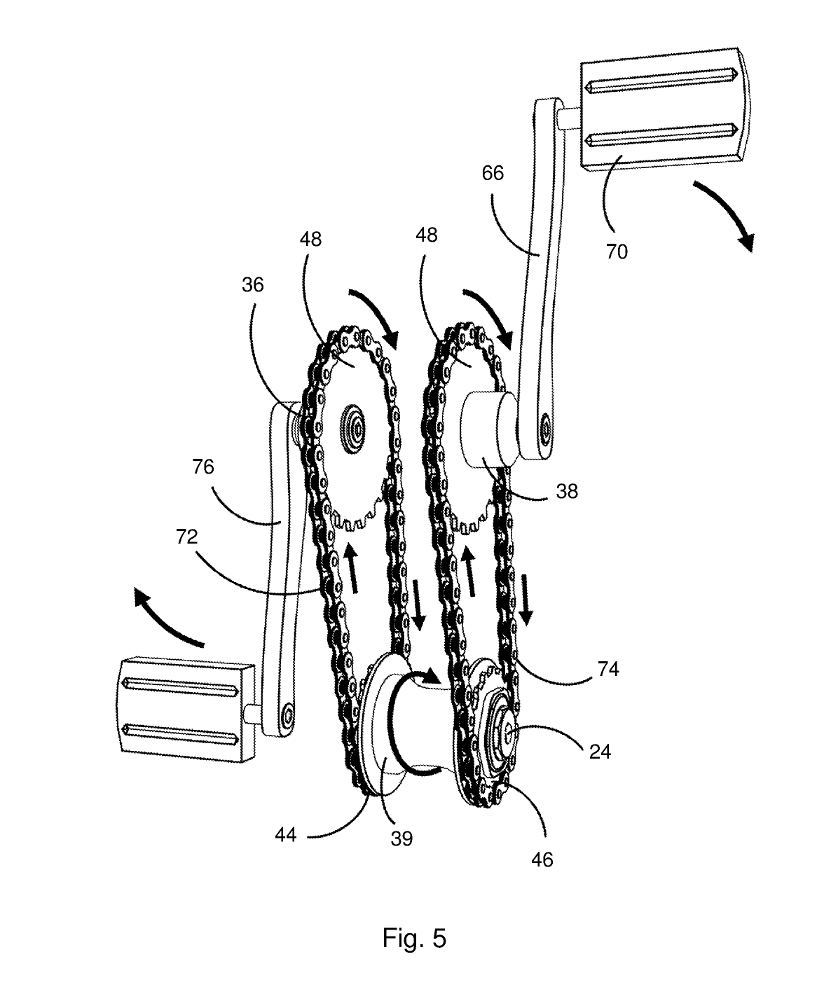

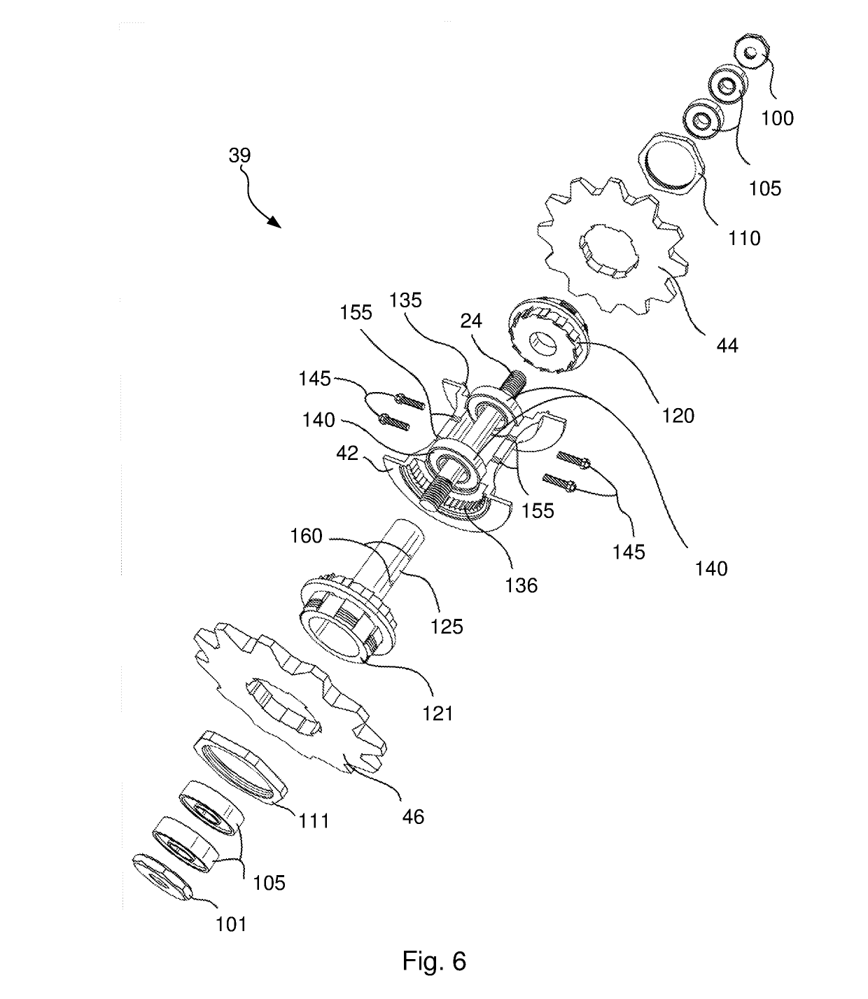

The dual chain drive in the proposed bicycle comprises a versatile double sided freewheel hub 39 as shown in FIGS. 5 and 6. The versatile double sided freewheel hub 39 is composed of a left side locknut 100, a right side locknut 101, four freewheel body bearings 105, a left side lockring 110 and a right side lockring 111, a left side sprocket 44 and a right side sprocket 46, a left side freewheel body 120 and a right side freewheel body 121, a freewheel link tube 125, a rear wheel hub axle 24 with opposite threading at each end, a hub shell 42, a left side tread ring 135 and a right side tread ring 136, internal hub bearings 140, and four fixed gear locking bolts 145. The components for the versatile double sided freewheel hub 39 are preferably formed of aluminium, chromolly, steel or titanium. However, it is understood by those skilled in the art, that other materials, such as carbon fiber and composite materials, which exhibit high strength and light weight characteristics, are also suitable for hub components.

Referring to FIG. 6, for the assembling of the versatile double sided freewheel hub 39, the rear wheel hub shell 42 is machined or otherwise shaped to snugly chamber at both ends internal hub bearings 140 and is fitted on both right and left ends with a left and right side threaded rings 135 and 136 respectively. The internal hub bearings 140 are press fitted into the rear wheel hub shell 42 on the left and right side. The freewheel link tube 125 which is welded or otherwise firmly attached to the right side freewheel body 121 is threaded through both internal hub bearings 140 until the right side freewheel body 121 is fully fitted into the matching right side threaded ring 136. The left side freewheel body 120 is then fully pressed into the left side threaded ring 135 and welded or otherwise firmly attached to the end of the freewheel link tube 125 which fits snugly into the left side freewheel body 120. The two pairs of freewheel bearings 105 are press fitted into the protruding sections of the left side freewheel body 120 and right side freewheel body 121 until they are flushed. The rear wheel hub axle 24 is then threaded through the freewheel bearings 105 until it protrudes at the opposite end stopping at the point when both protruding ends are of equal length. The left side locknut 100 and right side locknut 101 are then screwed on the respective ends of the rear wheel hub axle 24, ensuring the left side locknut 100 is screwed counter clockwise and the right side locknut 101 is screwed clockwise.

Still referring to FIG. 6 the sprockets 44 and 46 are mounted on their respective side freewheel body 120 and 121 and secured into place by the respective side lockring 110 and 111. The hub shell 42 and the freewheel link tube 125 have each four diametrically opposed and threaded perforations 155 and 160 respectively, two on the top side and two on the bottom side. The hub shell perforations 155 and the freewheel link tube perforations 160 are aligned when the two components are threaded by the fixed gear locking bolts 145.

The versatile double sided freewheel hub 39 in the present embodiment can be in either freewheel mode in its normal position or in fixed gear mode when adjusted. It is to be understood that this manner of changing a freewheel hub between freewheel mode and a fixed gear mode also would also apply to single chain bicycles. Referring to FIG. 6, the versatile double sided freewheel hub 39 in the present invention utilizes two freewheel bodies 120 and 121 which are of the pawl and ratchet variety. The pawls in the left side freewheel bodies 120 are positioned in an opposite direction to the pawls in the right side freewheel body 121, however when both bodies are mounted opposite to each other on the left and right side of the double sided freewheel hub 39, the pawls in both freewheel bodies 120 and 121 point forward. In other words, when the sprockets 44 and 46 are forced to rotate in a forward bound motion, the pawls in the freewheel bodies 120 and 121 engage the tread rings 135 and 136 simultaneously, as they are linked through the freewheel link tube 125, and they both force the double sided freewheel hub 39 and the rear wheel 22 to move forward.

In the normal freewheel position, when the rear wheel 22 is moving forward but the sprockets 44 and 46 are not driven to rotate along or rotate at a slower rate than the rear wheel 22, the pawls in both freewheel bodies 120 and 121 do not engage the tread rings 135 and 136 respectively, and simultaneously, as they are linked through the freewheel link tube 125, slip past each tooth in the tread rings which allows the bicycle to “coast.”

Referring to FIG. 6, to set the versatile double sided freewheel hub 39 in the fixed gear mode, the two pairs of fixed gear locking bolts 145 diametrically thread, from opposite ends, the hub shell 42, and the freewheel link 125 through the hub shell perforations 155 and the freewheel link tube perforations 160. When the four fixed gear locking bolts 145 are tightened in place, the freewheel bodies 120 and 121, are effectively affixed to the hub shell 42 thus any rotatory movement such as backwards or forwards of the sprockets 44 and 46 force the rear wheel 22 to rotate along and in the same direction, just like a standard fixed gear hub.

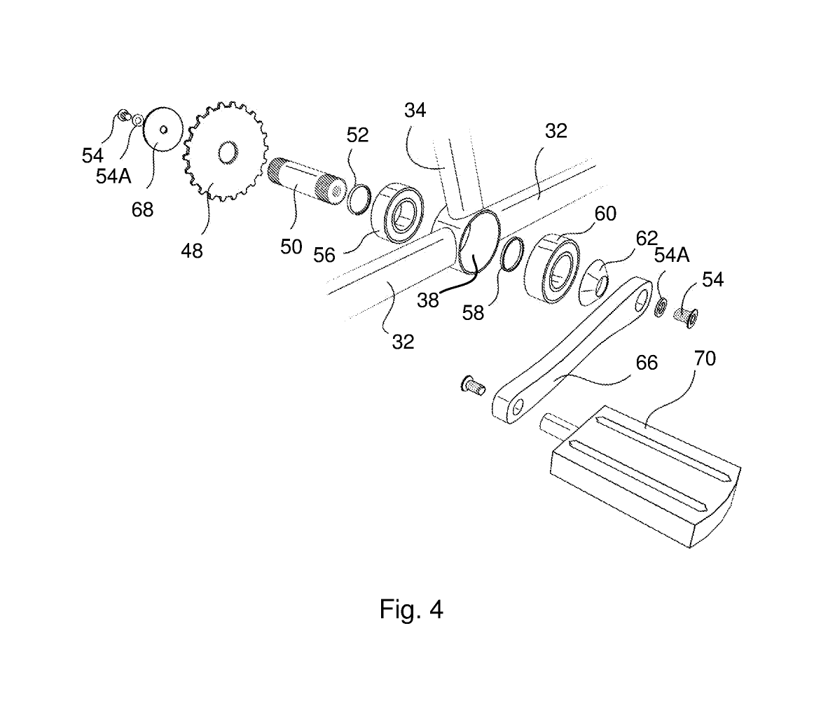

FIG. 4 shows a right side crankset assembly, including a fragmentary view of the bottom bracket shell and frame, it being understood that the opposite side crankset assembly as shown in FIG. 5 is a mirror image thereof. Each crankset is comprised of spindle screws 54, spindle screw washers 54A, a large washer 68, chanring 48 which can be of the splined drive type, a splined spindle 50, a chainring spacer 52, a inner sealed bearing 56, an internal bearing spacer 58, an outer sealed bearing 60, an outer dust cover 62, a crank-arm, such as the right crank-arm 66 that can be splined type, and a pedal such as the right pedal 70. Both parallel cranksets FIG. 4 and FIG. 5, are installed on the bottom bracket shells 36 and 38.

Still referring to FIG. 4, for the assembling of the crankset, the sealed bearings 56 and 60 are pressed fitted into the matching right bottom bracket shell 38 with the internal spacer 58 separating both, not unlike the installation of sealed bearings in mid-size type BMX bottom brackets. In alternative embodiments, the two sealed bearings 56 and 60 can be replaced by a single sealed bearing and dispensed with the internal spacer 58. In the present embodiment, both ends of the spindle 50 are splined. In alternative embodiments the outer end of the spindle 50 is welded to the crank-arm 66.

Referring to FIG. 4, after the sealed bearings 56 and 60 are pressed fitted into the bottom bracket shell 38, with the bearing spacer 58 between them, the right spindle 50, is threaded through both bearings. Then the chainring spacer 52 and chanring 48 are threaded on the inside side end of the spindle 50. After the spindle screw washer 54A and the large washer 68 are threaded on the spindle screw 54, the spindle screw 54 then secures the chainring 48 to the spindle 50. The outer dust cover 62 is then threaded on the other spindle end followed by the crank-arm 66, and the remaining spindle screw washer 54A. The remaining spindle screw 54 then holds the assemble together as it is screwed tight into the outer spindle end 50 which fits snugly into the large washer 68 much in the same manner that modern BMX crank-arms are attached to splined spindles. The pedal 70 is subsequently screwed on the crank-arm 66.

The same process is utilized to begin to assemble the left side crankset shown in FIG. 5 and in the same order. After that, the rear wheel 22, and the versatile double sided rear hub 39, with the roller chains, left chain 72 and right chain 74, threaded on the sprockets 44 and 46 are installed on the dropouts 26 and 28.

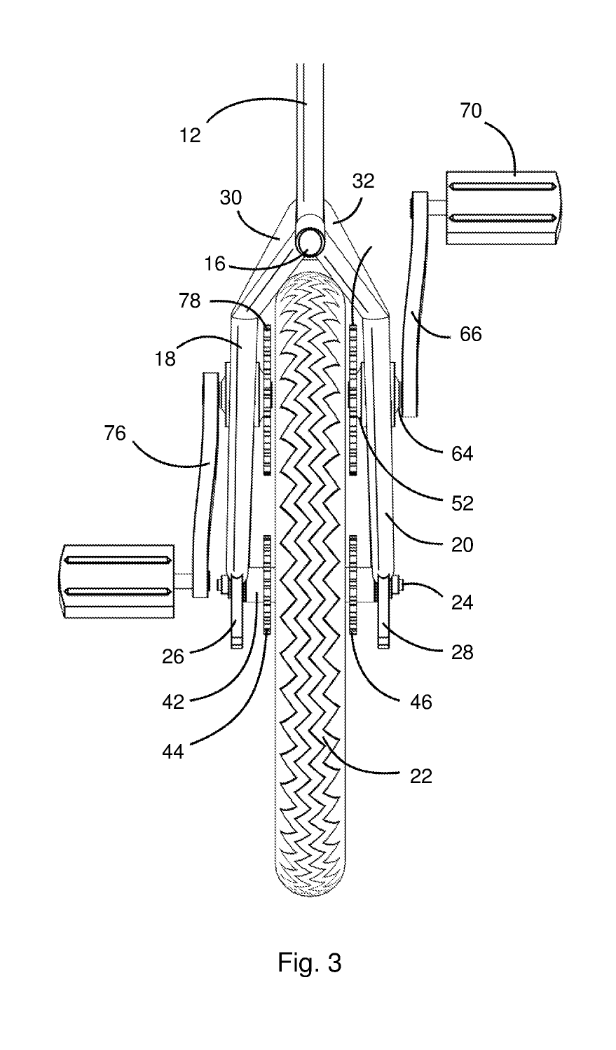

Referring to FIGS. 3 and 5, the left and right crank-arms 76 and 66 respectively, are aligned reciprocally. As in conventional bicycles, the crank-arms 76 and 66 must be set on their respective bottom bracket shells antipodally or one hundred and eighty degrees away prior to affixing both chains 72 and 74 on both chainrings 78 and 48.

The versatile double sided freewheel hub 39 in FIG. 6 allows for the mounting of different size sprockets, left sprocket 44 and right sprocket 46, on both ends. The two roller chains 72 and 74, are threaded around the respective side chainrings, left chainring 78 and right chainring 48, and their respective side sprockets 44 and 46. The bicycle chains 72 and 74 are of the roller type but in alternative embodiments they can be a belt drive type or more energy-efficient models.

Referring to FIGS. 4 and 5, in regular freewheel and fixed gear mode, at its forward position, pushing the right pedal 70 downwards drives the right spindle 50, the right chainring 48, the right roller chain 74, and the right sprocket 46 in a clockwise direction. The force applied by the roller chain on said sprocket 46 will in turn, drive the rear hub 42, the rear wheel 22, the left side sprocket 44, the left roller chain 72, and the left chainring 78 and crankset shown in FIG. 5 in the same direction as shown by the arrows.

In fixed gear mode, pedalling backwards drives the real wheel backwards or if in forward motion, it has the effect of bringing the bicycle to a stop. In freewheel mode, pedalling backwards or keeping the pedals in an idle position has no effect on the rear wheel and allows the bicycle to keep going forward or “to coast.” In short, while in freewheel or fixed gear mode the bicycle will behave as a typical freewheel or fixed gear bicycle respectively.

It is through the rear hub 39 as shown in FIG. 5 that both cranksets synchronize their rotatory movement in either direction and facilitate a smooth functioning of the overall drivetrain system. Pedaling in the present embodiment, is no different than pedaling in a conventional freewheel or fixed gear bicycle where the reciprocal motions of the rider's legs create an uninterrupted generation of power and move the bicycle forward or backward depending on the pedaling direction and mode.

Referring to FIG. 6, to switch the versatile double sided freewheel hub from the freewheel drive mode to the fixed gear mode, a rider, with the use of the appropriate tool such as a screwdriver, needs to thread first one of the fixed gear locking bolts 145 through the hub shell perforation 155, then slightly rotate the right side pedal 70 backwards, while holding the wheel steady ,which will have the effect of rotating the freewheel link tube 125 until the fixed gear locking bolt 145 is aligned with the respective freewheel link tube perforations 160. The rider can then further thread in the fixed gear locking bolt 145 until it can no longer be tightened by hand. The rider can then tighten the remaining fixed gear locking bolts 145. When all fixed gear locking bolts 145 are in place tightened by hand, the rider can then further tighten them with the use of the appropriate tool.

The bottom bracket shells of the present invention 36 and 38, as shown in FIGS. 1, 2 and 3, are significantly closer to the rear wheel hub axle 24 than conventional bottom bracket shells. This close distance allows for both the right and left roller chain length to be significantly shorter than a roller chain in a conventional bicycle with comparable frame dimensions.

Referring to FIGS. 3 and 5, in order to keep a comfortable distance between the cyclist's feet during pedaling motion, given that the bottom bracket shells 36 and 38 in the present embodiment are not in front of the rear wheel 22 as in conventional bicycles but alongside the rear wheel 22, the left spindle (not shown), the right spindle 50 and the bottom bracket shells 36 and 38 in the proposed drivetrain are significantly narrower in length than conventional bottom brackets shells and spindles.

The bottom bracket shells 36 and 38 are only large enough to steadily and securely support in place the left crankset assembly as in FIG. 5 and right crankset assembly FIG. 4, respectively.

As shown in FIGS. 1 and 3, the shorter distance between chainrings 78 and 48, and sprockets 44 and 46 respectively, improves the transmission of power through short and light roller chains 72 and 74. The short chains reduce chain drag and the waste of energy entailed from this and from the weight of the roller chain. Consequently energy is more effectively transmitted between chainrings 78 and 48 and sprockets 44 and 46 respectively in the present embodiment.

The close proximity to the rear wheel hub axle 24 of the bottom bracket shells 36 and 38, and the cranksets FIGS. 4 and 5, thereon installed, makes pulling the front wheel up easier for bunny hops and other similar manoeuvres. That feature also makes it easier to maintain balance during extreme manoeuvres involving exclusively and mostly the rear wheel. This is possible given that the cranksets are some of the heaviest components on the bicycle which affect weight distribution in a bicycle which in turn affects the centre of gravity of a bicycle. The proximity to the rear wheel hub axle 24 of the cranksets in the present embodiment as shown in FIG. 3, means that the centre of gravity of the bicycle is closer to the rear wheel hub axle 24 compared to conventional bicycles. This feature of the present embodiment creates a desirable condition for freestyle riders as it improves the balance and manoeuvrability of freestyle bicycles whose main purpose is to perform stunts which predominantly involve lifting the front wheel and using only the rear wheel as point of support. A centre of gravity at, or close to, the rear wheel hub axle is the ideal location for the centre of gravity of a freestyle bicycle as it ensures a centre of gravity consistently close to the point of support regardless of the bicycle's inclination angle. A centre of gravity close to the point of support also improves equilibrium and balance as it renders the bicycle and rider ensemble more stable during extreme stunts that rely heavily on lifting the front wheel.

As shown in FIG. 7, the right bottom bracket shell 38 and the left bottom bracket shell 36 (not labeled) are located in positions inside the outer diameter 160 of the rear wheel 22. This is not possible on a traditional bicycle having a single bracket shell. Front wheel 165 is shown in FIG. 7 in close proximity to down tube 14, which along with the location of the bracket shells 36 and 38 result in a smaller wheel base than as shown in FIG. 1.

By incorporating new features the bicycle in the present embodiment optimizes bicycle handling, weight and frame stiffness. In order to maintain the length of the reach of the present embodiment similar to that of equivalent size freestyle bicycles, and given the significantly shorter chainstay length, the top tube 12 and down tube 14 as shown in FIG. 1, are shorter in length than in equivalent freestyle bicycles. This reduction in turn decreases the distance between the front wheel axle 40 and rear wheel hub axle 24, known as wheelbase measurement. Shorter wheelbase and chainstay length mean a shorter more compact frame. While chainstay and wheelbase length are shorter in the present embodiment, other fundamental basic geometrical characteristics remain the same or similar to equivalent freestyle bicycles such as head tube angle, light weight, standover height, single speed gear, head tube designed to accept BMX or riser handle bars, a sturdy frame construction, and reach length.

Moreover the short wheelbase in the present embodiment facilitates faster turns and produces a more manoeuvrable and more responsive bicycle. The present embodiment too puts more weight closer to the rear wheel hub axle 24 providing more traction and power for tricks. The short wheelbase also makes the present bicycle climb better, which is another characteristic of freestyle bicycles. The present bicycle embodiment is, thanks to a more energy efficient drivetrain, a faster reacting bike for handling and for stunts and therefore it is an easier bicycle on which to bunny hop, to manual, to spin and do many other tricks. Compared to basic conventional bicycle drivetrains, the present bicycle drivetrain requires additional components such as a chainring, a bottom bracket shell, a spindle, two sealed bearings, a roller chain, and a rear hub sprocket ring. Notwithstanding the said additional components, there is no significant overall weight increase associated with said components given the following weight factors.

The roller chains in the present drivetrain 72 and 74 are substantially shorter than in a conventional drivetrain given the cranksets' close proximity to the rear wheel hub axle 24 as shown in FIG. 3. Thus the chains' combined weight would have roughly the equivalent weight and length of one conventional bicycle roller chain.

Furthermore, referring to FIGS. 4 and 5, the combined width of the two bottom brackets shells 36 and 38 is shorter than the width of a normal bottom bracket in a conventional bicycle and thus together they weight roughly less than one conventional bottom bracket shell. Also, the top tube 12 and down tube 14 as shown in FIGS. 1 and 2, are shorter in length than the top tube and down tube of a conventional 20 inch freestyle bicycle such as BMX bicycle.

The combined length of the left side spindle (not shown) and right spindle 50 in the present drivetrain setup is about the same length of one conventional spindle length. Thus there is no additional weight incurred by the two spindles in the present embodiment compared with the weight of a spindle of a conventional freestyle bicycle such as a BMX.

Furthermore, the weight savings associated with the reduction of the length of the top tube 12 and down tube 14, with the reduction of length of the bottom brackets shells 36 and 38, can roughly offset the weight increase associated with the pair of additional sealed bearings, a sprocket and a chainring. In short, no significant weight to the overall bicycle weight is added by the additional components in the present embodiment when compared to the weight of an equivalent conventional freestyle bicycle.

Various equivalents, combinations and variations may be made in the arrangement, operation and details of construction of the invention disclosed herein without departing from the spirit and scope of the invention. It is also to be understood that within the scope and spirit of the invention, the invention may be practiced other than as specifically described. The invention can certainly be applied to other bicycle disciplines that may benefit from a significantly shorter wheelbase for example. The present disclosure is intended to exemplify and not limit the application and usage of the invention.

It will be appreciated by persons skilled in the art that the present invention is not limited by what has been particularly shown and described herein. Rather the scope of the present invention includes both combinations and sub-combinations of the features described herein as well as modifications and variations thereof which would occur to a person of skill in the art upon reading the foregoing description and which are not in the prior art. Furthermore, many alterations and modifications are possible in the practice of this invention without departing from the spirit or scope thereof. Accordingly, the scope of the invention is to be construed in accordance with the substance defined by the following claims.

What is claimed is:

1. Apparatus for a bicycle comprising:
a bicycle frame comprising:
a top tube,
a head tube coupled to said top tube,
a down tube coupled to said head tube,
a seat tube coupled to said top tube and said down tube,
left and right chainstay tubes coupled to said down tube,
left and right seat stay tubes coupled to said seat tube,
a left dropout coupled to said left seat stay tube and said left chainstay tube,
a right dropout coupled to said right seat stay tube and said right chainstay tube,
a left bottom bracket shell coupled to said left chainstay tube, and
a right bottom bracket shell coupled to said right chainstay tube;
a rear wheel;
a set of spokes coupled to said rear wheel;
a double sided freewheel hub coupled to said rear wheel via said spokes and coupled to said left and right dropouts, said freewheel hub having a left sprocket and a right sprocket;
a left side crankset coupled to said left bottom bracket shell, said left side crankset having a left chain ring;
a right side crankset coupled to said right bottom bracket shell, said right side crankset having a right chain ring;
a left chain coupled to said left chain ring and to said left sprocket such that rotation of said left side crankset causes said rear wheel to rotate; and
a right chain coupled to said right chain ring and to said right sprocket such that rotation of said right side crankset causes said rear wheel to rotate.

2. The apparatus of claim 1 further comprising:
a left seat stay bridge tube coupled to said left bottom bracket shell and to said left seat stay tube; and
a right seat stay bridge tube coupled to said right bottom bracket shell and to said right seat stay tube.

3. The apparatus of claim 2 further comprising a chainstay bridge tube coupled between said left chainstay tube and said right chainstay tube.

4. The apparatus as in claim 3 further comprising:
a front wheel coupled to said head tube,
a handbar coupled to said head tube,
a seat; and
a seat post coupled to said seat and coupled to said seat tube.

5. The apparatus as in claim 4 wherein said left crankset comprises a left pedal,
a left crankarm coupled to said left chain ring and to said left pedal; and
said right crankset comprises
a right pedal, and
a right crankarm coupled to said right chain ring and to said right pedal.

6. The apparatus as in claim 5 wherein said double sided freewheel hub can be switched between a fixed gear hub and a freewheel hub without uninstalling said double sided freewheel hub.

7. The apparatus as in claim 5 wherein said double sided freewheel hub can be switched from a freewheel hub to a fixed gear hub by inserting locking bolts therethrough.

8. The apparatus as in claim 7 wherein said double sided freewheel hub comprises:
a rear wheel hub shell having left and right tread rings,
internal hub bearings press fitting into said rear wheel hub shell,
a right side freewheel body,
a freewheel link tube firmly coupled to said right side freewheel body, said freewheel link tube threaded through said internal hub bearings such that said right side freewheel body is coupled to said right tread ring,
a left side freewheel body firmly coupled to said freewheel link tube and coupled to said left tread ring,
freewheel bearings are press fit into said left side freewheel body and said right side freewheel body until said bearings are flush with said left and right side freewheel bodies,
a rear wheel hub axle threaded through said freewheel bearings, said rear wheel hub axle coupled to said left and right dropouts.

9. The apparatus as in claim 8 wherein rotation of said left and right chains is synchronized by said double sided freewheel hub.

10. The apparatus as in claim 9, said freewheel hub further comprising a second left sprocket and a second right sprocket such that said left chain can change from said left sprocket to said second left sprocket and said right chain can change from said right sprocket to said second right sprocket to change gears.

11. The apparatus as in claim 4 wherein said front wheel has a front point of contact with a ground and said rear wheel has a rear point of contact with said ground such that a distance between said front point of contact and said rear point of contact is shorter than a corresponding distance for a conventional bicycle.

12. The apparatus as in claim 11 wherein said right bottom bracket shell and said left bottom bracket shell are positioned inside an outer diameter of said rear wheel.

13. The apparatus as in claim 12 wherein said bicycle is a regular bicycle.

14. Apparatus for a bicycle comprising:
a bicycle frame comprising:
a top tube,
a head tube coupled to said top tube,
a down tube coupled to said head tube,
a seat tube coupled to said top tube and said down tube,
left and right chainstay tubes coupled to said down tube,
left and right seat stay tubes coupled to said seat tube,
a left dropout coupled to said left seat stay tube and said left chainstay tube,
a right dropout coupled to said right seat stay tube and said right chainstay tube,
a right bottom bracket shell coupled to said right chainstay tube;
a rear wheel;
a set of spokes coupled to said rear wheel;
a double sided freewheel hub coupled to said rear wheel via said spokes and coupled to said left and right dropouts, said freewheel hub having a right sprocket;
a right side crankset coupled to said right bottom bracket shell, said right side crankset having a right chain ring; and
a chain coupled to said right chain ring and to said right sprocket such that rotation of said right side crankset causes said rear wheel to rotate.

15. The apparatus as in claim 14 wherein said double sided freewheel hub can be switched between a fixed gear hub and a freewheel hub without uninstalling said double sided freewheel hub.

16. The apparatus as in claim 14 wherein said double sided freewheel hub can be switched from a freewheel hub to a fixed wheel hub by inserting locking bolts therethrough.

17. The apparatus as in claim 15 wherein said double sided freewheel hub can be switched from a freewheel hub to a fixed wheel hub by inserting locking bolts therethrough.

18. The apparatus as in claim 14 wherein said bicycle is a regular bicycle.
